(19) United States
(12) Patent Application Publication
(10) Pub. No.: US 2017/0320998 A1
(43) Pub. Date: Nov. 9, 2017

(54) FUNCTIONALIZED POLYURETHANES PREPARED FROM RENEWABLE MATERIALS

(71) Applicant: Henkel IP & Holding GmbH, Duesseldorf (DE)

(72) Inventors: Andrew D. Messana, Newington, CT (US); David P. Dworak, Middletown, CT (US); Anthony F. Jacobine, North Haverhill, NH (US); Angelica Messana, Newington, CT (US)

(21) Appl. No.: 15/660,595

(22) Filed: Jul. 26, 2017

Related U.S. Application Data
(63) Continuation of application No. PCT/US2015/063629, filed on Dec. 3, 2015.
(60) Provisional application No. 62/107,635, filed on Jan. 26, 2015.

(51) Int. Cl. C08G 18/67; C08G 18/80; C08G 18/75; C08G 18/81; C08G 18/36

(52) U.S. Cl. CPC C08G 18/672; C08G 18/8116; C08G 18/36; C08G 18/755; C08G 18/8051

(57) ABSTRACT

The present invention relates to curable polyurethane polymers made from renewable materials. In particular hydroxylated oleaginous materials derived from plant oils, such as soybean oil, are used. These renewable materials may be formed into curable polyurethane polymers having different chemical functionalities and cure mechanisms.

### FIELD OF THE INVENTION

The invention relates generally to the preparation of functionalized polyurethanes made from renewable materials and compositions made therefrom. More particularly, the invention relates to the preparation of polyurethanes from hydroxylated plant oils and curable compositions made therefrom.

### BACKGROUND OF RELATED TECHNOLOGY

There is a current emphasis on renewable sources for materials, particularly as a means of replacing petroleum-based products. A number of companies have focused on modifying plant oils to include functional groups which are useful for further reactions and producing polymer materials. For example, U.S. Pat. No. 6,891,053 discloses a method of making oleochemical oil-based polyols by mixing an epoxidized oleochemical, such as a vegetable or animal fat, and an alcohol using an activated or acid leached-clay to form the oleo-chemical oil-based polyol. U.S. Pat. Nos. 8,757,294 and 8,575,378 disclose other methods of making modified plant-based polyols by using a plant oil which includes at least one C≡C group and reacting that group with a nucleophilic functional group and an active hydrogen group. The result is specific plant oils which have hydroxyl functionalization useful for further reaction, such as the reaction with an amine compound to form a polyurethane.

Recently, commercially available modified plant oils having hydroxyl functionality have been commercially available as renewable sources for making materials. For example, several soy-based_polyols sold under the brand Agrol by Biobased Technologies, Springdale, Ariz., are disclosed as being useful sources of renewable polyols which may be used for making polyurethanes.

There is need for a process which uses renewable materials such as plant oils to form polyurethane polymers which contain (meth)acrylate, alkoxy, and other functionality.

### BRIEF DESCRIPTION OF THE DRAWINGS

FIG. 1 shows the gel permeation chromatography (GPC) trace of the starting olechemical oil-based polyol, Agrol 3.6 (peak retention time ˜2.3 min., PDI=2.29). After extension with isophorone diisocyante, the molecular weight has increased significantly as denoted by the broad GPC trace, as well as the increase in the PDI of the material (1.70) and Mw (5,013 from 2,218). FIG. 1 illustrates that oleochemical oil-based polyols can be extended into polyurethanes using diisocyantes.

### SUMMARY OF THE INVENTION

In one aspect of the invention, polymerizable resin is formed which includes:
a) polymer corresponding to the structure:

MA-U-A-U-MA

wherein A includes an oleaginous backbone derived from hydroxylated plant oil, U includes a urethane linkage and MA includes a group selected from a (meth)acrylate-containing group, a moisture curing group, such as an alkoxy group, and combinations thereof. and
b) a cure system selected from one of a free radical initiator system, a moisture cure system and combinations thereof.

In another aspect of the invention there is disclosed a method for forming a polymerizable (meth)acrylate-functionalized polyurethane polymer which includes, reacting a (meth)acrylate-functionalized isocyanate compound with an hydroxylated oleaginous compound derived from a renewable source, said reacting being conducted for a time and at a temperature sufficient to form a polymerizable (meth)acrylate-functionalized polyurethane compound.

In another aspect of the invention there is disclosed a method for forming a polymerizable alkoxy-functionalized polyurethane polymer which includes, reacting an alkoxy-functionalized isocyanate compound with an hydroxylated oleaginous compound derived from a renewable source, said reacting being conducted for a time and at a temperature sufficient to form a polymerizable alkoxy-functionalized polyurethane compound.

In another aspect of the invention, there is disclosed a curable resin composition which includes the aforementioned MA-U-A-MA structure and a cure system, said cure system selected from a free radical initiator system, a moisture cure system, and combinations thereof.

In another aspect of the invention the invention there is included a method of making a curable (meth)acrylate-functionalized polyurethane having a backbone derived from soybean which includes the reaction steps of reacting an hydroxylated soybean oil with a (meth)acrylate-terminated isocyanate to form the (meth)acrylate-functionalized polyurethane.

In yet another aspect of the invention there is provided a curable (meth)acrylate- and alkoxy-functionalized polyurethane which includes the steps of reacting a soybean oil containing isocyanato and (meth)acrylate functionality with an amine containing alkoxy functionality.

In yet another aspect of the invention there is provided a method of forming a curable polyurethane polymer from a renewable source which includes:
a) forming a polyurethane polymer by reacting an hydroxylated oleaginous component, derived from a plant oil and containing one or more alkoxy C₁₋₄ groups, with a diisocyanate; and
b) further reacting said polyurethane polymer with compound containing (i) a reactive amino group and a moisture curing group, or (ii) with a reactive hydroxyl group containing a (meth)acrylate functionality.

In yet another aspect of the invention there is provided a method of making a curable polyurethane polymer having alkoxy functionality which includes reacting a plant oil containing alkoxy and isocyanate functionality with a silane containing amino functionality.

### DETAILED DESCRIPTION OF THE INVENTION

The present invention provides new processes and curable polymers/compositions using bio-based polyol materials, such as plant oils. Plant oils generally require modification to include hydroxyl groups in their chemical structure, and such products are currently commercially available. The present invention includes the use of such bio-based polyols, for either direct reaction with an appropriate (meth)acrylate-containing or alkoxy-containing isocyanate compound to form curable polyurethanes, or via an extended method, which includes first reacting the bio-based polyol with a diisocyanate and then further reacting the resultant product with a hydroxyl-containing (meth)acrylate, to yield a (meth)acrylated polyurethane. Moreover, additional modifications of the bio-based polyol may be made such that NCO groups and/or moisture curable groups, such as alkoxy groups C₁₋₄, may be incorporated into the bio-based polyol. In such cases, the resultant polyurethane formed therefrom may also have moisture curing capability.

A variety of renewable hydroxylated plant oils (also known as bio-based polyols) may be used in the present invention. For example, oils such as soybean oil almond oil, canola oil, coconut oil, cod liver oil, corn oil, cottonseed oil, flaxseed oil, linseed oil, olive oil, palm oil, peanut oil, safflower oil, sesame oil, sunflower oil, walnut, castor oil and combinations thereof, may be used.

Among the preferred renewable hydroxylated plant oils are those commercially under the trade name Agrol, sold by Biobased Technologies, Springfield, Ark., as further described herein. The Agrol polyols are hydroxylated soybean oils, which are derived for natural soybean. The degree of hydroxylation may vary and hydroxyl values from 70 to 200 mg KOH/g may be employed. The viscosity of these soybean-derived polyols may vary from about 200 to about 3,000 at 25° C. and hydroxyl functionality can range from 1.7 to 7.0 eq/mol.

Diisocyantes useful in the present invention include, without limitation, isophorone diisocyanate (IPDI), IPDI isocyanaurate, polymeric IPDI, naphthalene 1,5-diisocyanate (NDI), methylene bis-cyclohexylisocyanate, methylene diphenyl diisocyanate (MDI), polymeric MDI, toluene diisocyanate (TDI), isocyanaurate of TDI, TDI-trimethylolpropane adduct, polymeric TDI, hexamethylene diisocyanate (HDI), HDI isocyanaurate, HDI biurate, polymeric HDI, xylylene diisocyanate, hydrogenated xylylene diisocyanate, tetramethyl xylylene diisocyanate, p-phenylene diisocyanate, 3,3′-dimethyldiphenyl-4,4′-diisocyanate (DDDI), 2,2,4-trimethylhexamethylene diisocyanate (TMDI), norbornane diisocyanate (NDI), and 4,4′-dibenzyl diisocyanate (DBDI). Combinations of diisocyantes may also be used. Monoisocyantes may also be used in the present invention.

Among the useful (meth)acrylate-containing hydroxyl compounds useful for reaction with the NCO functionalized bio-based polyols include, without limitation, 2-hydroxyethyl methacrylate, 2-hydroxyethyl acrylate, 3-hydroxypropyl methacrylate, 3-hydroxypropyl acrylate, 2-hydroxypropyl acrylate, 4-hydroxybutyl acrylate, 3-hydroxybutyl acrylate, 2-hydroxybutyl acrylate, 3-(acryloyloxy)-2-hydroxypropyl methacrylate, 2-isocyanatoethyl methacrylate, 2-isocyanatoethyl acrylate, and poly(propylene glycol) (meth)acrylate.

Among the useful (meth)acrylate-containing isocyanates useful for reaction with the bio-based polyols include, without limitation, 2-isocyanatoethyl acrylate, 2-isocyanatoethyl methacrylate, 3-isocyanatopropyl (meth)acrylate, 2-isocyanatopropyl (meth)acrylate, 4-isocyanatobutyl (meth)acrylate, 3-isocyanatobutyl (meth)acrylate, and 2-isocyanatobutyl (meth)acrylate.

Among the useful alkoxy-containing isocyanates useful for reaction with the bio-based polyols include, without limitation, 3-isocyanatopropyltriethoxysilane, 3-isocyanatopropylmethyldiethoxysilane, 3-isocyanatopropyldimethylethoxysilane, 3-isocyanatopropyltrimethoxysilane,

3-isocyanatopropylmethyldimethoxysilane, and 3-isocyanatopropyldimethylmethoxysi lane.

Among the useful alkoxy-containing amines for use in the invention include 4-aminobutyltriethoxysilane, 4-aminobutylmethyldiethoxysilane, 4-aminobutyldimethylethoxysilane, 4-aminobutyltrimethoxysilane, 4-aminobutylmethyldimethoxysilane, 4-aminobutyldimethylmethoxysilane, 4-amino-3,3-dimethylbutylmethyldimethoxysilane, dimethylbutyltrimethoxysilane, 1-amino-2-(dimethylethoxysilyl)propane, 3-(m-aminophenoxy)propyltrimethoxysilane, m-aminophenyltrimethoxysilane, m-aminophenyltriethoxysilane, 3-aminopropyltriethoxysilane, 3-aminopropylmethyldiethoxysilane, 3-aminopropyldimethyethoxysilane, 3-aminopropyltrimethoxysilane, 3-aminopropylmethyldimethoxysilane, 3-aminopropyldimethymethoxysilane, 3-aminopropylmethylbis(trimethylsiloxy)silane, 3-aminopropylpentamethyldisiloxane, 11-aminoundecyltriethoxysilane, and 11-aminoundecyltrimethoxysilane.

As mentioned herein, when the bio-based polyol also includes other reactive groups such a NCO groups and/or alkoxy groups, resultant polyurethanes formed therefrom may have these groups available for further reactions. For example, the presence of a reactive NCO group on the bio-based polyol allows for reaction with an amine group to form a urea linkage. Thus, the inventive polyurethanes formed from the bio-based polyols used in the present invention allow for a variety of polyurethane end products having such functionalities as (meth)acrylate and/or alkoxy functionality, which in turn allows for free radical and/or moisture curing mechanisms to be employed in the final curable compositions made therefrom.

A variety of curable compositions may be made from the polyurethanes of the invention. For example, adhesive compositions, sealants and coatings are among the useful products which may be formed from the inventive renewable compositions.

The polyurethane compositions of the present invention may be incorporated into curable compositions having free radical, UV and/or moisture cure mechanisms.

When incorporated into compositions which cure via free radical mechanisms, the compositions will usually include a free radical initiator. Examples of useful free radical initiators include, without limitation, hydroperoxides, such as cumene hydroperoxide, paramenthane hydroperoxide, tertirary butyl hydroperoxide, and peresters which hydrolyze to peroxides such as tertiary butyl perbenzoate, and the like. The amount of such peroxy compounds may vary from about 0.1 to about 10, preferably about 1 to about 5, percent by weight of the total composition.

When incorporated into compositions which photocure, the compositions will usually include a photoinitiator. Useful photoinitiators include, without limitation, 1-hydroxycyclohexyl phenyl ketone, 2-methyl-1-[4-(methylthio)phenyll]-2-morpholino propan-1-one, 2-benzyl-2-N,N-dimethylamino-1-(4-morpholinophenyl)-1-butanone, the combination of 1-hydroxy cyclohexyl phenyl ketone and benzophenone, 2,2-dimethoxy-2-phenyl acetophenone, the combination of bis(2,6-dimethoxybenzoyl-2,4,4-trimethyl pentyl) phosphine oxide and 2-hydroxy-2-methyl-1-phenyl-propan-1-one, and [bis (2,4,6-trimethyl benzoyl) phenyl phosphine oxide], 2-hydroxy-2-methyl-1-phenyl-1-propan-1-one, the combination of 2,4,6-trimethylbenzoyldiphenyl-phosphine oxide and 2-hydroxy-2-methyl-1-phenyl-propan-1-one, dl-camphorquinone, alkyl pyruvates, 2,2-dimethoxy-2-phenyl acetophenone, 2-hydroxy-2-methyl-1-phenyl-1-propane, bis(2,4,6-trimethyl benzoyl) phenyl phosphine oxide, bis(2,6-di methoxybenzoyl-2,4,4-trimethylpentyl) phosphine oxide, 2-hydroxy-2-methyl-1-phenyl-propan-1-one, bis(n⁵-2,4-cyclopentadien-1-yl)-bis[2,6-difluoro-3-(1H-pyrrol-1-yl)phenyl]titanium, diethoxyacetophenone and combinations thereof. Photoinitiators may be used in amount of about 0.001% to about 2.0% by weight of the total composition.

Accelerators may also be advantageously included. Such accelerators include a variety of secondary and tertiary organic amines as well as sulfimides (e.g., benzoic sulfimide) which are also known in the art. These may be used at a concentration range of about 0.1 to about 5, desirably about 1 to about 2, percent by weight of the total composition.

Other agents such as thickeners, plasticizers, etc., are also known in the art and may advantageously be incorporated where functionally desirable, provided only that they do not interfere with the functioning of the additive for its intended purpose.

### Syntheses for Preparing Curable Functionalized Polyurethane Polymers

The curable functionalized polyurethane polymers of the present invention may be formed using more than one method. Desirably the polyurethane polymers have (meth)acrylate functionality, but other functionalities are contemplated and may be achieved.

In a first method (“Direct Method”), the hydroxylated oleaginous component derived from plant oil is directly reacted with a (meth)acrylate component containing a free NCO group to directly form curable (meth)acrylate-functionalized polyurethane polymers. These polyurethane polymers may contain one or more moisture curing groups.

Desirably the equivalents ratio of OH:NCO in the reactants is about 0.1 to 3.0. More desirably the equivalents ratio of OH:NCO in the reactants is about 0.4 to about 2.0, and even more desirably about 0.8 to about 1.0 equivalents of OH:NCO.

The reaction is run in reactor with or without a suitable solvent. When solvents are employed, polar solvents such as toluene, tetrahydrofuran (THF), ethyl acetate, xylenes, and the like may be employed. The reaction is generally run at temperatures of about 25° C. to about 100° C., preferably about 40° C. to about 80° C., and more preferably about 60° C. to about 75° C. Metal-based catalysts, such as dibutyltin dilaurate among others as further described herein, may be used in amounts of about 0.01% to about 5 wt %, preferably 0.5% to about 2 wt %, and more preferably about 0.1% to about 1.0 wt %, based on the weight of the total reaction mixture. Desirably, the reaction is carried out for as long as required to substantially fully react the isocyanate and hydroxyl groups. Reaction times may range from about 2 to about 24 hours, preferably about 3 to about 12 hours, and more preferably about 4 to about 8 hours. The resultant curable (meth)acrylate-functionalized/alkoxy-functionalized polyurethane polymer has incorporated therein at least a (hydroxylated oleaginous and portion of, and desirably substantially all of the oleaginous component.

In a second method (“Extended Method”) a hydroxylated oleaginous component derived from plant oil is reacted with a diisocyanate to form a polyurethane intermediate. The stoichiometry of the reactants is controlled such that the polyurethane intermediate contains unreacted pendent NCO groups, intended to be used for further reaction. That is, pendent NCO groups remain on the polyurethane intermediate for further reaction with, for example, a hydroxyl containing (meth)acrylate component, a polyfunctional alcohol component, or an alkoxy-containing amine component. The amount of residual NCO may be about 5 to 90 wt %, to preferably 25 to 70 wt %, and more preferably 30 to 60%.

The equivalents ratio of OH to NCO in the starting reactants diisocyanate components) is about desirably 0.1 to about 10.0, more desirably about 0.2 to 3.0, and even more desirably about 0.5 to about 2.0 equivalents of OH to NCO. The reaction is run in a reactor with or without a suitable solvent. When solvents are employed, polar solvents such as toluene, tetrahydrofuran (THF), ethyl acetate, xylenes, and the like may be employed. The reaction is generally run at temperatures of about 25° C. to about 100° C., desirably about 40° C. to about 80° C., and more desirably about 60° C. to about 75° C. Metal-based catalysts, such as dibutyltin dilaurate (among others, as further described herein), may be used in amounts of about 0.01% to about 5%, desirably 0.5% to about 2%, and more desirably about 0.1% to about 1.0%, based on the weight of the total reaction mixture. The reaction is carried out for as long as required to substantially fully react the hydroxyl groups with NCO groups. The reaction times may vary from about 2 to about 24 hours, desirably 3 to 12 hours, and more desirably 4 to 8 hours. Due to the excess NCO groups present in the reaction, the formed intermediate polyurethane will contain pendent NCO groups which are available for reaction with additional components. For example, the intermediate polyurethane may be further reacted, if desired, with a component(s) containing hydroxyl groups, alkoxy groups or amine groups. For example, the intermediate polyurethane polymer may be reacted with an aminosilane compound which includes alkoxy functionality for moisture curing. One particularly desirable further reaction includes the reaction of the intermediate polyurethane with an hydroxyl-containing (meth)acrylate component (e.g. 2-hydroxyethyl (meth)acrylate (HEMA)), to yield curable (meth)acrylate-functionalized polyurethane polymers. Desirably the equivalents ratio of NCO:OH in the reaction of the intermediate polyurethane with the hydroxyl-containing (meth)acrylate component is about 1:0.01 to about 1:1.2. This reaction yields a curable (meth)acrylate-functionalized polyurethane polymer useful for a variety of applications as previously mentioned. The reaction of the intermediate polyurethane with the hydroxyl-containing (meth)acrylate component is carried out for as long as required to fully react the isocyanate and hydroxyl groups. Typically, the reaction time may range from about 2 to about 12 hours, preferably about 3 to about 12 hours, and more preferably 4 to 8 hours.

The amount of renewable content present in the intermediate and final polymers made in accordance with the present invention may range from about 30% to about 70% by weight, more desirably about 45% to about 60% by weight. Due to the selection of the specific hydroxylated oleaginous material, the end products formed may contain a hard (relatively rigid) segment (attributed to the reaction of the diisocyanate with short chain diols present in the hydroxylated oleaginous materials) of about 1 to about 10% and desirably about 2% to about 5% by weight.

One particularly useful method of preparing the polyurethanes of the present invention include the following reaction steps:

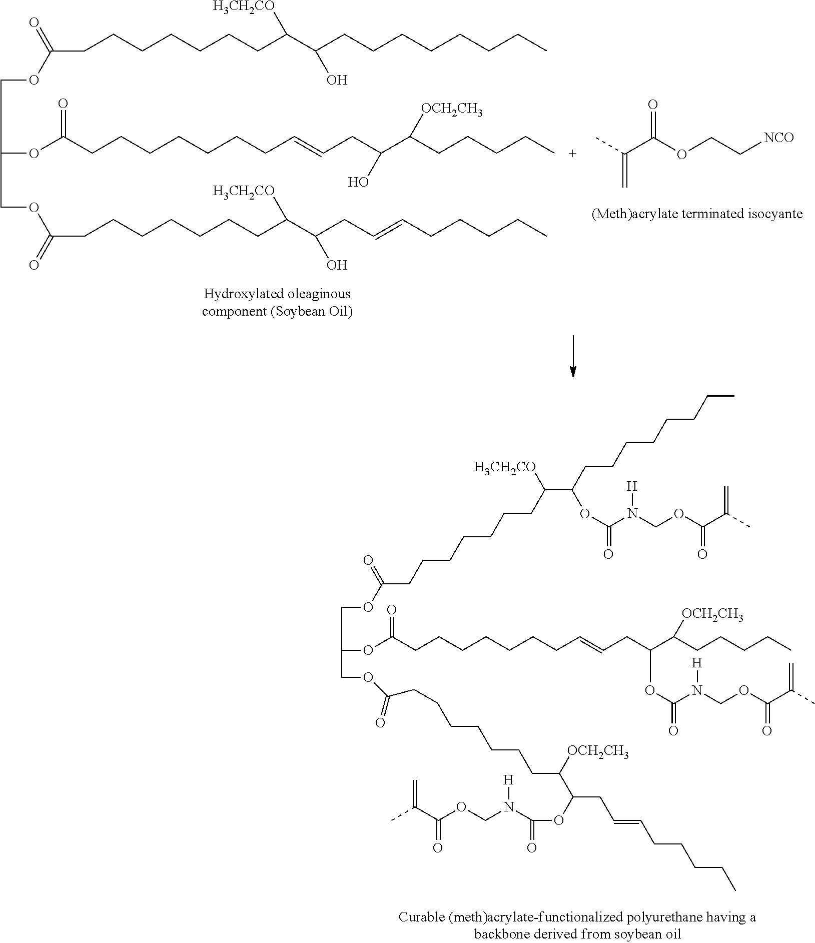

Another particularly useful method of preparing the polyurethanes of the present invention include the following reaction steps:

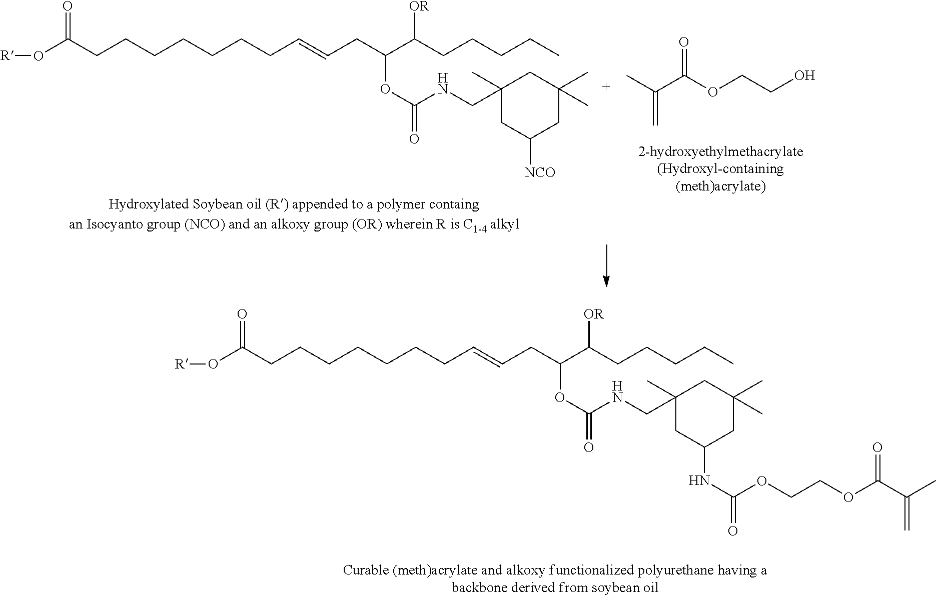

Yet another particularly useful method of preparing the polyurethanes of the present invention include the reaction steps of:

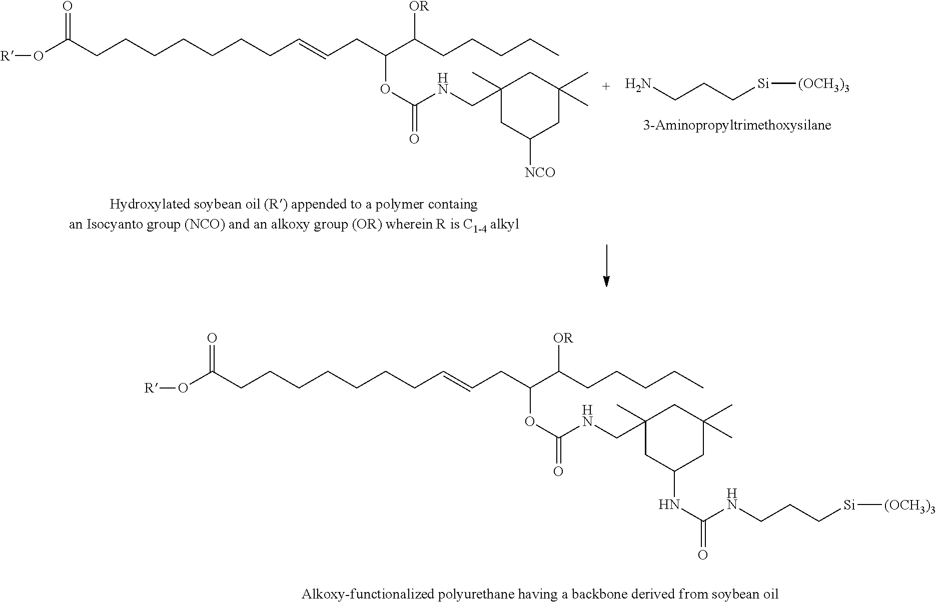

### EXAMPLES

Agrol 2.0 is the trade name for an hydroxylated soybean oil derived from natural soybean having hydroxyl values of 65-75, an acid value (mg KOH/g)≦1.0, a viscosity of about 233 at 25° C. available from BioBased Technologies, Springfield, Ark.

Agrol 3.6 is the trade name for an hydroxylated soybean oil derived from natural soybean having hydroxyl values of 107-117, an acid value (mg KOH/g)≦1.0, a viscosity of about 720 at 25° C. available from BioBased Technologies, Springfield, Ark.

Pomoflex 6156 is a bio-based polyol derived from succinic acid and propane diol made by Piedmont Chemical Industries I, LLC, 331 Burton Avenue, High Point, N.C. 27262. It has a molecular weight of about 2,000, a functionality of 2.0, a hydroxyl number of 56 mg KOH/g and an acid value (mg KOH/g)<1.

### Example 1

### Preparation of a Curable (Meth)Acrylate-Functionalized Polyurethane Using the Extended Method Described Above (Methacrylated Agrol 2.0/IPDI (1.0:1.72) Polyurethane Resin)

To a 2-L jacketed polymerization reactor equipped with a thermocouple, stirrer, condenser, and nitrogen inlet/oulet was added Agrol 2.0 (374.61 g, 0.1766 moles), dibutyltin dilaurate (0.24 g, 0.0004 moles), 3-(3,5-ditert-butyl-4-hydroxyphenyl)propanoic acid, [3-[3-(3,5-ditert-butyl-4-hydroxyphenyl)-1-oxopropoxy]-2,2-bis[[3-(3,5-ditert-butyl-4-hydroxyphenyl)-1-oxopropoxy]methyl]propyl] ester (0.096 g, 0.00008 moles), 4-methoxyphenol (0.096 g, 0.0008 moles), and phosphoric acid (0.013 g, 0.00014 moles). The contents were heated to 60° C. and allowed to mix for 15 minutes. Isophorone diisocyanate (IPDI) (71.49 g, 0.321 moles) was added and allowed to react for about +2 hours. A titration was then performed to determine the residual isocyanate content. Hydroxyethylmethacrylate (36.92 g, 0.284 moles) was then added and allowed to react for 3 hours at 60° C. This reaction resulted in the formation of a clear and yellow and viscous methacrylated polyurethane resin (451.6 g, 93.4% yield).

### Example 2

### Preparation of a Curable (Meth)Acrylate-Functionalized Polyurethane Using the Extended Method Described Above (Methacrylated Agrol 2.0/IPDI (1.0:2.0) Polyurethane Resin)

To a 2-L jacketed polymerization reactor equipped with a thermocouple, stirrer, condenser, and nitrogen inlet/oulet was added Agrol 2.0 (228.78 g, 0.1407 moles), dibutyltin dilaurate (0.17 g, 0.0003 moles), 3-(3,5-ditert-butyl-4-hydroxyphenyl)propanoic acid [3-[3-(3,5-ditert-butyl-4-hydroxyphenyl)-1-oxopropoxy]-2,2-bis[[3-(3,5-ditert-butyl-4-hydroxyphenyl)-1-oxopropoxy]methyl]propyl] ester (0.096 g, 0.00008 moles), 4-methoxyphenol (0.069 g, 0.0006 moles), and phosphoric acid (0.009 g, 0.00009 moles). The contents were heated to 60° C. and allowed to mix for 15 minutes. Isophorone diisocyante (IPDI) (65.51 g, 0.295 moles) was added and allowed to react for +2 hours. A titration was then performed to determine the residual isocyanate content. Hydroxyethylmethacrylate (44.65 g, 0.343 moles) was then added and allowed to mix for 3 hours at 60° C. This reaction resulted in the formation of a clear and yellow, viscous methacrylated polyurethane resin (329.4 g, 94.1% yield).

### Example 3

### Preparation of a Curable (Meth)Acrylate-Functionalized Polyurethane Using the Extended Method Described Above (Methacrylated Agrol 3.6/IPDI (1.0:2.0) Polyurethane Resin)

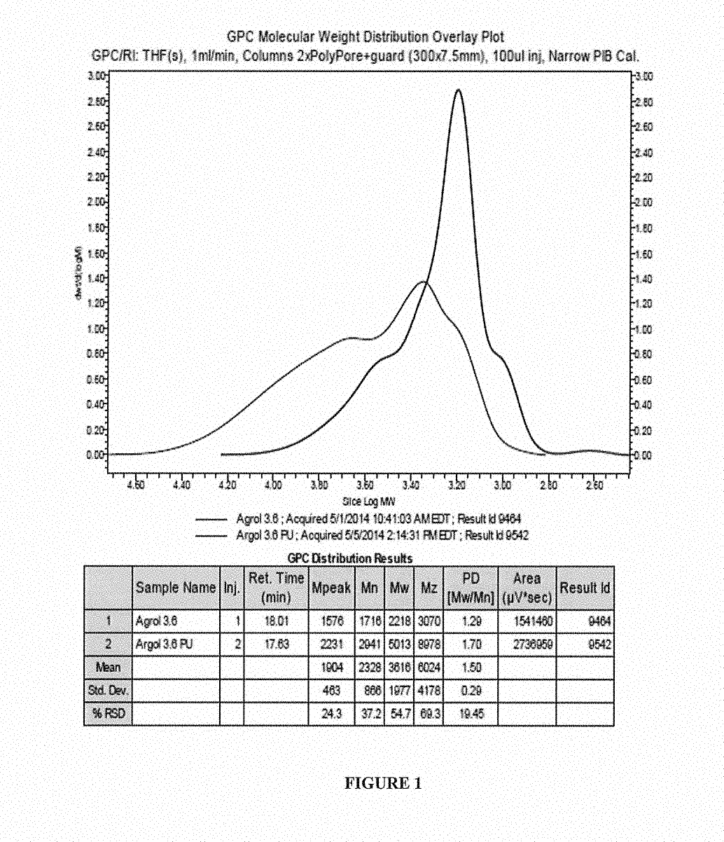

To a 2-L jacketed polymerization reactor equipped with a thermocouple, stirrer, condenser, and nitrogen inlet/oulet was added Agrol 3.6 (582.61 g, 0.3739 moles), dibutyltin dilaurate (0.49 g, 0.0008 moles), and phosphoric acid (0.025 g, 0.0003 moles). The contents were heated to 60° C. and allowed to mix for 15 minutes. Isophorone diisocyante (IPDI) (256.52 g, 1.154 moles) was added and allowed to react for +2 hours. A titration is then performed to determine the residual isocyanate content. Hydroxyethylmethacrylate (168.68 g, 1.296 moles) was then added and allowed to mix for 3 hours at 60° C. This reaction resulted in the formation of a clear and yellow, viscous methacrylated polyurethane resin (931.7 g, 92.4% yield. GPC analysis of this material shows the Agrol 3.6 before and after the reaction. FIG. 1 below shows the increased molecular weight growth and dramatic broadening of the polydispersity index, which is indicative of polyurethane resins.

### Example 4

Preparation of a Curable (Meth)Acrylate-Functionalized Polyurethane Using the Extended Method Described Above (Methacrylated Agrol 3.6 and IPDI (1.0:2.0) Polyurethane Resin with IPDI and HEMA Hard Block Moities Prepared In Situ)

To a 2-L jacketed polymerization reactor equipped with a thermocouple, stirrer, condenser, and nitrogen inlet/oulet was added isophorone diisocyanate (68.00 g, 0.310 moles), hydroxyethylmethacrylate (19.81 g, 0.152 moles), dibutyltin dilaurate (0.21 g, 0.0003 moles), 3-(3,5-ditert-butyl-4-hydroxyphenyl)propanoic acid, [3-[3-(3,5-ditert-butyl-4-hydroxyphenyl)-1-oxopropoxy]-2,2-bis[[3-(3,5-ditert-butyl-4-hydroxyphenyl)-1-oxopropoxy]methyl]propyl] ester (0.021 g, 0.00002 moles), 4-methoxyphenol (0.021 g, 0.0002 moles), and phosphoric acid (0.009 g, 0.00009 moles). The contents were heated to 65° C. and allowed to react for +1 hour. Agrol 3.6 (79.45 g, 0.0495 moles) was then added and allowed to mix for +2 hours. A titration was then performed to determine the residual isocyanate content. Hydroxyethylmethacrylate (40.98 g, 0.284 moles) was then added and allowed to mix for 3 hours at 60° C. This reaction resulted in the formation of a clear and yellow, viscous methacrylated polyurethane resin (193.4 g, 93.8% yield).

### Example 5

Preparation of a Curable (Meth)Acrylate-Functionalized Polyurethane Using the Direct Method Described Above (Methacrylated Agrol 4.0 and IPDI (1.0:2.0) Polyurethane Resin with IPDI and HEMA Hard Block Moities Prepared In Situ)

To a 2-L jacketed polymerization reactor equipped with a thermocouple, stirrer, condenser, and nitrogen inlet/oulet was added isophorone diisocyanate (IPDI) (250.00 g, 1.125 moles), hydroxyethylmethacrylate (58.27 g, 0.448 moles), dibutyltin dilaurate (1.47 g, 0.0023 moles), 3-(3,5-ditert-butyl-4-hydroxyphenyl)propanoic acid, [3-[3-(3,5-ditert-butyl-4-hydroxyphenyl)-1-oxopropoxy]-2,2-bis[[3-(3,5-ditert-butyl-4-hydroxyphenyl)-1-oxopropoxy]methyl]propyl] ester (0.084 g, 0.0001 moles), 4-methoxyphenol (0.021 g, 0.0002 moles), and phosphoric acid (0.08 g, 0.0008 moles). The contents were heated to 65° C. and allowed to react for +1 hour. Agrol 4.0 (275.93 g, 0.1831 moles) was then added and allowed to mix for +2 hours. A titration is then performed to determine the residual isocyanate content. Hydroxyethylmethacrylate (176.3 g, 1.223 moles) was then added and allowed to mix for 3 hours at 60° C. This reaction resulted in the formation of a clear and yellow, viscous methacrylated polyurethane resin (794.3 g, 94.2% yield).

### Example 6

Preparation of a Curable (Meth)Acrylate-Functionalized Polyurethane Using the Direct Method Described Above (Methacrylated Pomoflex 6156 and IPDI (1.0:2.0) Polyurethane Resin with IPDI and HEMA Hard Block Moities Prepared In Situ)

To a 2-L jacketed polymerization reactor equipped with a thermocouple, stirrer, condenser, and nitrogen inlet/oulet was added isophorone diisocyanate (IPDI)(222.3 g, 1.00 moles), hydroxyethylmethacrylate (51.96 g, 0.399 moles), dibutyltin dilaurate (2.01 g, 0.0031 moles), 3-(3,5-ditert-butyl-4-hydroxyphenyl)propanoic acid, [3-[3-(3,5-ditert-butyl-4-hydroxyphenyl)-1-oxopropoxy]-2,2-bis[[3-(3,5-ditert-butyl-4-hydroxyphenyl)-1-oxopropoxy]methyl]propyl] ester (0.123 g, 0.0001 moles), 4-methoxyphenol (0.123 g, 0.0001 moles), and phosphoric acid (0.08 g, 0.0008 moles). The contents were heated to 65° C. and allowed to react for +1 hour. Pomoflex 6156 (567.64 g, 0.2833 moles) was then added and allowed to mix for +2 hours. A titration is then performed to determine the residual isocyanate content.

### Example 7

### Preparation of a Curable (Meth)Acrylate-Functionalized Polyurethane Using the Extended Method Described Above (Methacrylated Pomoflex 6156 and IPDI (1.0:2.0) Polyurethane Resin)

To a 2-L jacketed polymerization reactor equipped with a thermocouple, stirrer, condenser, and nitrogen inlet/oulet was added Pomoflex 6156 (150.00 g, 0.0749 moles), dibutyltin dilaurate (0.41 g, 0.0007 moles), 3-(3,5-ditert-butyl-4-hydroxyphenyl)propanoic acid, [3-[3-(3,5-ditert-butyl-4-hydroxyphenyl)-1-oxopropoxy]-2,2-bis[[3-(3,5-ditert-butyl-4-hydroxyphenyl)-1-oxopropoxy]methyl]propyl] ester (0.026 g, 0.00002 moles), 4-methoxyphenol (0.026 g, 0.0002 moles), and phosphoric acid (0.006 g, 0.00006 moles). The contents were heated to 60° C. and allowed to mix for 15 minutes. Isophorone diisocyante (35.14 g, 0.1581 moles) was added and allowed to react for +2 hours. A titration is then performed to determine the residual isocyanate content. Hydroxyethylmethacrylate (18.10 g, 0.139 moles) was then added and allowed to mix for 3 hours at 60° C. This reaction resulted in the formation of a clear and yellow, viscous methacrylated polyurethane resin (192.9 g, 94.7% yield).

### Example 8

### Preparation of a Curable (Meth)Acrylate-Functionalized Polyurethane Using the Direct Method Described Above (Methacrylated Agrol 2.0)

To a 2-L jacketed polymerization reactor equipped with a thermocouple, stirrer, condenser, and nitrogen inlet/oulet was added Argol 2.0 (101.50 g, 0.0734 moles), dibutyltin dilaurate (0.08 g, 0.0001 moles), 3-(3,5-ditert-butyl-4-hydroxyphenyl)propanoic acid, [3-[3-(3,5-ditert-butyl-4-hydroxyphenyl)-1-oxopropoxy]-2,2-bis[[3-(3,5-ditert-butyl-4-hydroxyphenyl)-1-oxopropoxy]methyl]propyl] ester (0.020 g, 0.00002 moles), 4-methoxyphenol (0.020 g, 0.0002 moles), and phosphoric acid (0.008 g, 0.00008 moles). The contents were heated to 60° C. and allowed to mix for 15 minutes; 2-ethylcyanomethacrylate (40.49 g, 0.0261 moles) was then added and allowed to react for +4 hours. FT-IR was used to measure the consumption of isocyanate groups until reaction completion. Yield was 156.6 g (99.2% yield).

### Example 9

### Preparation of a Curable (Meth)Acrylate-Functionalized Polyurethane Using the Extended Method Described Above (Methacrylated Pomoflex 61212 and IPDI (1.0:2.0) Polyurethane Resin)

To a 2-L jacketed polymerization reactor equipped with a thermocouple, stirrer, condenser, and nitrogen inlet/oulet was added Pomoflex 61212 (345.48 g, 0.6528 moles), dibutyltin dilaurate (1.63 g, 0.003 moles), 3-(3,5-ditert-butyl-4-hydroxyphenyl)propanoic acid, [3-[3-(3,5-ditert-butyl-4-hydroxyphenyl)-1-oxopropoxy]-2,2-bis[[3-(3,5-ditert-butyl-4-hydroxyphenyl)-1-oxopropoxy]methyl]propyl] ester (0.102 g, 0.00009 moles), 4-methoxyphenol (0.102 g, 0.0008 moles), and phosphoric acid (0.019 g, 0.0002 moles). The contents were heated to 60° C. and allowed to mix for 15 minutes. Isophorone diisocyante (296.01 g, 1.332 moles) was added and allowed to react for +2 hours. A titration is then performed to determine the residual isocyanate content. Hydroxyethylmethacrylate (110.87 g, 0.852 moles) was then added and allowed to mix for 3 hours at 60° C. This reaction resulted in the formation of a clear and yellow, viscous methacrylated polyurethane resin (788.9 g, 93.4% yield).

1. A polymerizable polymer corresponding to the structure:
MA-U-A-U-MA
wherein A comprises an oleaginous backbone derived from hydroxylated plant oil, U comprises a urethane linkage and MA comprises a member selected from the group consisting of a (meth)acrylate-containing group, an alkoxy-containing group and combinations thereof.

2. The polymerizable polymer of claim 1, wherein the oleaginous backbone is derived from hydroxylated soybean oil almond oil, canola oil, coconut oil, cod liver oil, corn oil, cottonseed oil, flaxseed oil, linseed oil, olive oil, palm oil, peanut oil, safflower oil, sesame oil, sunflower oil, walnut, castor oil and combinations thereof.

3. The polymerizable polymer of claim 1, wherein the hydroxylated plant oil has a hydroxyl functionality from about 1.0 to about 7.0.

4. The polymerizable polymer of claim 1, wherein the (meth)acrylate-containing group comprises a reactant residue selected from the group consisting of 2-hydroxyethyl methacrylate, 2-hydroxyethyl acrylate, 3-hydroxypropyl methacrylate, 3-hydroxypropyl acrylate, 2-hydroxypropyl acrylate, 4-hydroxybutyl acrylate, 3-hydroxybutyl acrylate, 2-hydroxybutyl acrylate, 3-(acryloyloxy)-2-hydroxypropyl methacrylate, 2-isocyanatoethyl methacrylate, 2-isocyanatoethyl acrylate, poly(propylene glycol) (meth)acrylate, 2-isocyanatoethyl acrylate, 2-isocyanatoethyl methacrylate, 3-isocyanatopropyl (meth)acrylate, 2-isocyanatopropyl (meth)acrylate, 4-isocyanatobutyl (meth)acrylate, 3-isocyanatobutyl (meth)acrylate, and 2-isocyanatobutyl (meth)acrylate.

5. The polymer of claim 1, wherein U further comprises a diisocyanate reactant residue selected from the group consisting of isophorone diisocyanate (IPDI), IPDI isocyanaurate, polymeric IPDI, naphthalene 1,5-diisocyanate (NDI), methylene bis-cyclohexylisocyanate, methylene diphenyl diisocyanate (MDI), polymeric MDI, toluene diisocyanate (TDI), isocyanaurate of TDI, TDI-trimethylolpropane adduct, polymeric TDI, hexamethylene diisocyanate (HDI), HDI isocyanaurate, HDI biurate, polymeric HDI, xylylene diisocyanate, hydrogenated xylylene diisocyanate, tetramethyl xylylene diisocyanate, p-phenylene diisocyanate, 3,3′-dimethyldiphenyl-4,4′-diisocyanate (DDDI), 2,2,4-trimethylhexamethylene diisocyanate (TMDI), norbornane diisocyanate (NDI) and 4,4′-dibenzyl diisocyanate (DBDI).

6. The polymer of claim 1, wherein the alkoxy-containing group comprises a reactant residue selected from the group consisting of 3-isocyanatopropyltriethoxysilane, 3-isocyanatopropylmethyldiethoxysilane, 3-isocyanatopropyldimethylethoxysilane, 3-isocyanatopropyltrimethoxysilane, 3-isocyanatopropylmethyldimethoxysilane, 3-isocyanatopropyldimethylmethoxysilane, 4-aminobutyltriethoxysilane, 4-aminobutylmethyldiethoxysilane, 4-aminobutyldimethylethoxysilane, 4-aminobutyltrimethoxysilane, 4-aminobutylmethyldimethoxysilane, 4-aminobutyldimethylmethoxysilane, 4-amino-3,3-dimethylbutylmethyldimethoxysilane, dimethylbutyltrimethoxysilane, 1-amino-2-(dimethylethoxysilyl)propane, 3-(m-aminophenoxy)propyltrimethoxysilane, m-aminophenyltrimethoxysilane, m-aminophenyltriethoxysilane, 3-aminopropyltriethoxysilane, 3-aminopropylmethyldiethoxysilane, 3-aminopropyldimethyethoxysilane, 3-aminopropyltrimethoxysilane, 3-aminopropylmethyldimethoxysilane, 3-aminopropyldimethymethoxysilane, 3-aminopropylmethylbis(trimethylsiloxy)silane, 3-aminopropylpentamethyldisiloxane, 11-aminoundecyltriethoxysilane, and 11-aminoundecyltrimethoxysilane

7. A curable resin composition comprising the reaction product of claim 1 and a cure system, said cure system selected from the group consisting of a free radical initiator system, a moisture cure system and combinations thereof.

8. A polyurethane prepared by the reaction product of:
a) an NCO-terminated polymer formed from the reaction of an hydroxylated oleaginous component derived from plant oil and a diisocyante; and
b) a component selected from the group consisting of an hydroxylated (meth)acrylate monomer an alkoxy-functionalized monomer and combinations.

9. The reaction product of claim 8 wherein the hydroxylated oleaginous component derived from plant oil comprises hydroxylated soybean oil.

10. The reaction product of claim 7, wherein the diisocyante is selected from the group consisting of isophorone diisocyanate (IPDI), IPDI isocyanaurate, polymeric IPDI, naphthalene 1,5-diisocyanate (NDI), methylene bis-cyclohexylisocyanate, methylene diphenyl diisocyanate (MDI), polymeric MDI, toluene diisocyanate (TDI), isocyanaurate of TDI, TDI-trimethylolpropane adduct, polymeric TDI, hexamethylene diisocyanate (HDI), HDI isocyanaurate, HDI biurate, polymeric HDI, xylylene diisocyanate, hydrogenated xylylene diisocyanate, tetramethyl xylylene diisocyanate, p-phenylene diisocyanate, 3,3′-dimethyldiphenyl-4,4′-diisocyanate (DDDI), 2,2,4-trimethylhexamethylene diisocyanate (TMDI), norbornane diisocyanate (NDI), and 4,4′-dibenzyl diisocyanate (DBDI).

11. A method of forming a polyurethane polymer from a renewable source, said polyurethane polymer being (meth)acrylate functionalized and/or alkoxy functionalized, said method comprising:
a) forming a polyurethane polymer by reacting an hydroxylated oleaginous component derived from plant oil with a diisocyanate;
b) reacting said polyurethane polymer with (i) a (meth)acrylate monomer containing hydroxyl functionality to yield said curable (meth)acrylate-functionalized polyurethane polymer; or (ii) reacting said polyurethane with an alkoxy monomer containing amine and/or isocyante functionality to yield said curable alkoxy-functionalized monomer.

12. The method of claim 11, wherein the hydroxylated oleaginous component derived from plant oil comprises soybean oil.

13. The method of claim 11, wherein the ratios of OH/NCO equivalents are form 0.1 to 10.0.

14. The method of claim 13, wherein the reaction is carried out until substantially all NCO groups are reacted with OH groups.

15. The method of claim 11, wherein the reaction further includes a metal-based catalyst.

16. A polymerizable resin comprising:
a) polymer corresponding to the structure:
MA-U-A-U-MA
wherein A comprises an oleaginous backbone derived from hydroxylated plant oil, U comprises a urethane linkage and MA comprises a (meth)acrylate-containing group optionally containing one or more moisture curable groups;
b) a cure system selected from the group consisting of a free radical initiator system, a moisture cure system and combinations thereof.

17. A method for forming a polymerizable (meth)acrylate-functionalized polyurethane polymer comprising, reacting a (meth)acrylate-functionalized isocyanate compound with an hydroxylated oleaginous compound derived from a renewable source, said reacting being conducted for a time and at a temperature sufficient to form a polymerizable (meth)acrylate-functionalized polyurethane compound.

18. A method for forming a polymerizable alkoxy-functionalized polyurethane polymer comprising, reacting an alkoxy-functionalized isocyanate compound with a hydroxylated oleaginous compound derived from a renewable source, said reacting being conducted for a time and at a temperature sufficient to form a polymerizable alkoxy-functionalized polyurethane compound.

19. The method of claim 17, wherein the reacting is carried out at temperatures of about 25° C. to 100° C. for about 2 to about 24 hours.

20. The method of claim 18, wherein the reacting is carried out at temperatures of about 25° C. to 100° C. for about 2 to about 24 hours.

21. The method of claim 17, wherein the hydroxylated oleaginous compound is a plant oil.

22. The method of claim 18, wherein the hydroxylated oleaginous compound is a plant oil.

24. The method of claim 17, wherein the oleaginous compound comprises soybean oil.

25. The method of claim 18, wherein the oleaginous compound comprises soybean oil.

26. The method of claim 22, wherein the soybean oil has a hydroxyl functionality form about 1.0 to about 7.0.

27. The method of claim 17, wherein the (meth)acrylate-functionalized isocyanate compound is selected from the consisting of 2-methacryloyloxethyl isocyanate and 2-acryloyloxethyl isocyanate.

28. The method of claim 17, wherein the (meth)acrylated isocyanate compound contains alkoxy functional groups.

29. The method of claim 18, wherein the alkoxy-functionalized isocyanate compound is selected from the consisting of 3-isocyanatopropyltriethoxysilane, 3-isocyanatopropylmethyldiethoxysilane, 3-isocyanatopropyldimethylethoxysilane, 3-isocyanatopropyltrimethoxysilane, 3-isocyanatopropylmethyldimethoxysilane and 3-isocyanatopropyldimethylmethoxysilane.

30. The method of claim 17, comprising the reaction scheme:

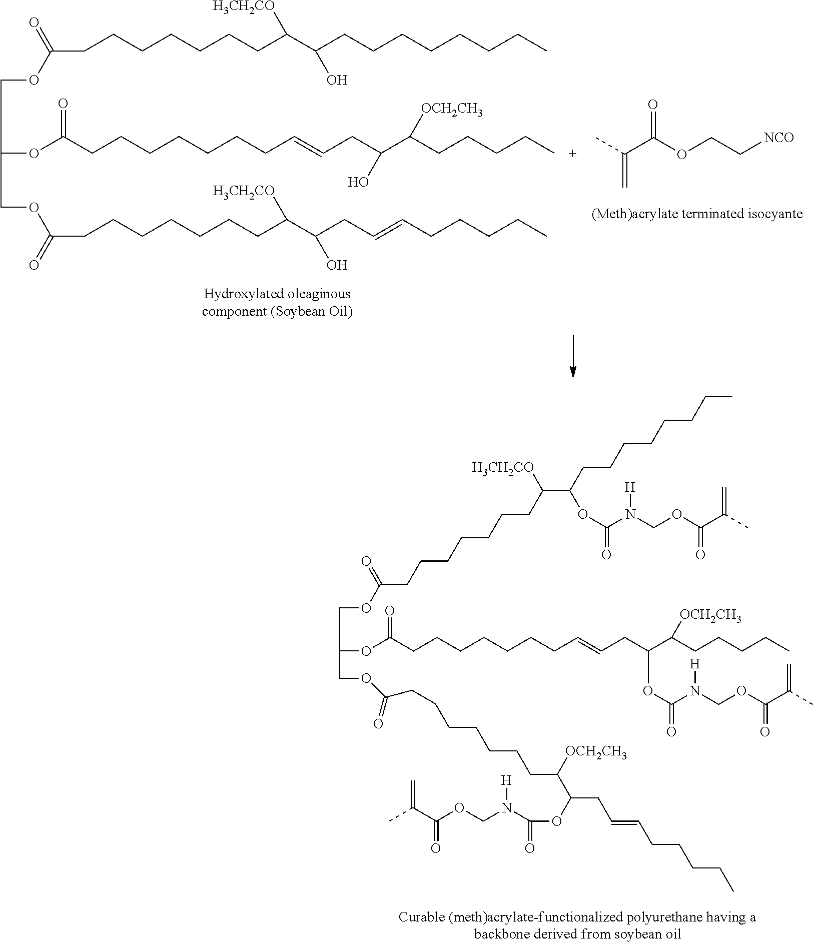

31. The method of claim 11, comprising the reaction scheme:

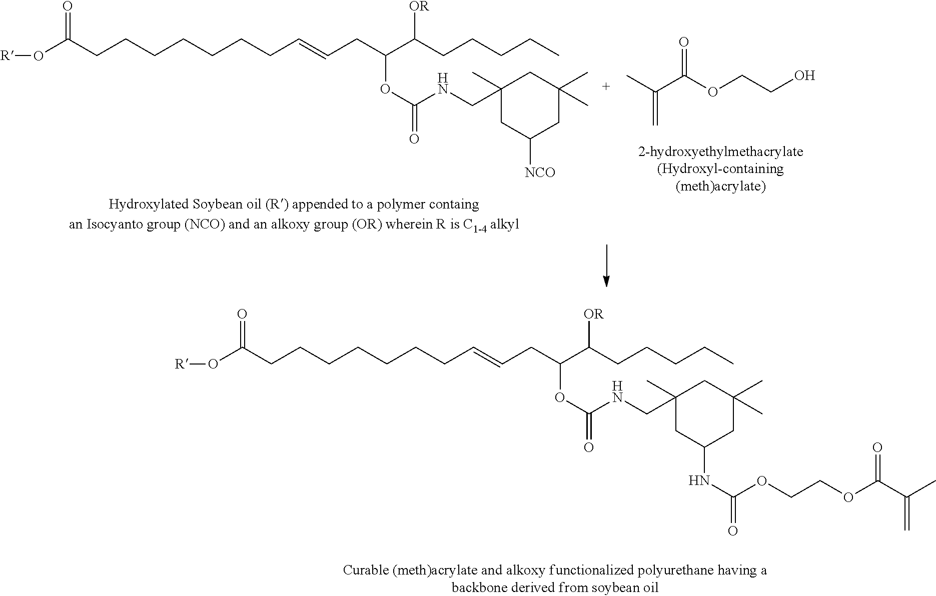

32. A method of forming a curable polyurethane polymer from a renewable source comprising:
a) forming a polyurethane polymer by reacting an hydroxylated oleaginous component derived from a plant oil with a diisocyanate containing one or more alkoxy C₁₋₄ groups; and
b) further reacting said polyurethane polymer with compound containing a reactive amino group and a moisture curing group.

33. The method of claim 25 comprising the reaction scheme: [chemical structure]
